(19) United States
(12) Patent Application Publication
(10) Pub. No.: US 2023/0410125 A1
(43) Pub. Date: Dec. 21, 2023

(54) BLOCKCHAIN-BASED TRANSPARENT SUPPLY CHAIN AUTHENTICATION METHOD AND APPARATUS, AND DEVICE AND MEDIUM

(71) Applicant: INSPUR SUZHOU INTELLIGENT TECHNOLOGY CO., LTD., Suzhou, Jiangsu (CN)

(72) Inventors: Kaizhi LIN, Suzhou, Jiangsu (CN); Chao DING, Suzhou, Jiangsu (CN)

(21) Appl. No.: 18/037,859

(22) PCT Filed: Dec. 30, 2021
(86) PCT No.: PCT/CN2021/143255

§ 371 Date: May 19, 2023

(30) Foreign Application Priority Data
Jan. 16, 2021 (CN) 202110058583.3

(51) Int. Cl. G06Q 30/018; G06F 16/27

(52) U.S. Cl. CPC G06Q 30/018; G06F 16/27

(57) ABSTRACT

Disclosed are a blockchain-based transparent supply chain authentication method and apparatus, and a device and a medium. The method comprises: storing, in a blockchain storage system, a transparent supply chain certificate and original asset information which are assigned to a server when same leaves a factory, so as to obtain a blockchain feature value, and storing the blockchain feature value in a preset non-volatile storage space of the server; if the server is started, reading the current asset information of the server and reading the blockchain feature value; searching the blockchain storage system by using the blockchain feature value, so as to obtain a target transparent supply chain certificate and target original asset information, and comparing the current asset information with the target original asset information; and if the current asset information is consistent with the target original asset information, issuing the target transparent supply chain certificate to the server, such that the server acquires a working permission on the basis of the target transparent supply chain certificate. By means of the solution of the present application, automated and trusted transparent supply chain authentication of a server is realized.

### CROSS-REFERENCE TO RELATED APPLICATION

The present disclosure claims the priority of the Chinese patent application filed on Jan. 16, 2021 before the China National Intellectual Property Administration with the application number of 202110058583.3 and the title of “BLOCKCHAIN-BASED TRANSPARENT SUPPLY CHAIN AUTHENTICATION METHOD AND APPARATUS, AND DEVICE AND MEDIUM”, the content of which is incorporated herein in its entirety by reference.

### FIELD

The present disclosure relates to the field of server technology, and in particular, to a method for authenticating a transparent supply chain based on a blockchain, and an apparatus, a device and a medium thereof.

### BACKGROUND

Concerns have grown in recent years that counterfeit electronic parts could cause failure of business-critical applications. For example, in 2011, the US Congress passed new legislation requiring procurement to be governed by Cost Accounting Standards (CAS) to “detect and avoid counterfeit electronic parts”. Further for example, in 2015, the Department of Defense Federal Acquisition Regulation Supplement (DFARS) expanded these requirements. In order to facilitate monitoring traceability of the procurement of individual parts, to enable end users to trace original part manufacturers of these parts, a transparent supply chain (TSC for short) has been proposed.

FIG. 1 shows an existing authentication method for a transparent supply chain of a server. That is, a transparent-supply-chain database is adopted to record tracing information of parts on the transparent supply chain, and a SN (Series Number) number of a mainboard of the server is consistent with information of the supply chain, or in a condition that there is trusted platform module (TPM) of the server, a TPM certificate of the server matches a transparent-supply-chain certificate, which confirms that the supply chain of the server is authenticated so that the server is to allowed to run relevant trust programs, and is used to trace the supply chain after an occurrence of a problem.

### SUMMARY

According to a first aspect of the present disclosure, a method for authenticating a transparent supply chain based on a blockchain is provided, and the method includes:
storing a transparent-supply-chain certificate and original asset information, assigned to a server at an ex-factory time of the server, in a blockchain storage system, to obtain a feature value of the blockchain, and storing the feature value of the blockchain in a preset nonvolatile storage space of the server;
in response to that the server is started, reading current asset information of the server, and reading the feature value of the blockchain in the preset nonvolatile storage space of the server;
querying in the blockchain storage system by using the feature value of the blockchain, to obtain a target transparent-supply-chain certificate and target original asset information, and comparing the current asset information with the target original asset information; and
in response to that the current asset information is consistent with the target original asset information, assigning the target transparent-supply-chain certificate to the server, to make the server obtain a work authority based on the target transparent-supply-chain certificate.

In an embodiment, the method further includes:
obtaining maintenance record data of the server, and determining an asset-information-change record according to the maintenance record data; and
storing the asset-information-change record in the blockchain storage system.

In an embodiment, the querying in the blockchain storage system by using the feature value of the blockchain to obtain the target transparent-supply-chain certificate and the target original asset information and comparing the current asset information with the target original asset information, includes:
determining a target block based on the feature value of the blockchain;
in response to that no asset-information-change record is presented in the target block, using the original asset information stored in the target block as target asset information;
in response to that the asset-information-change record is presented in the target block, determining the target asset information according to the original asset information stored in the target block and the asset-information-change record; and using the transparent-supply-chain certificate stored in the target block as the target
transparent-supply-chain certificate.

In an embodiment, the method further includes:
in response to that the current asset information is inconsistent with the target original asset information, obtaining maintenance record data of the server, and determining an asset-information-change record according to the maintenance record data;
determining whether the current asset information inconsistent with the target original asset information is consistent with the asset-information-change record; and
in response to that the current asset information inconsistent with the target original asset information is consistent with the asset-information-change record, sending the target transparent-supply-chain certificate to the server, to make the server obtain the work authority based on the target transparent-supply-chain certificate.

In an embodiment, the method further includes:
storing a local certificate in a trusted platform module (TPM) of the server in advance, and comparing the target transparent-supply-chain certificate with the local certificate stored in the trusted platform module of the server;
in response to that the target transparent-supply-chain certificate is the same as the local certificate, allowing the server to use the target transparent-supply-chain certificate to obtain the work authority; and
in response to that the target transparent-supply-chain certificate is not the same as the local certificate, preventing the server from using the target transparent-supply-chain certificate to obtain the work authority.

In an embodiment, the preset nonvolatile storage space is an EEPROM electronic tag in a field replaceable unit (FRU) provided in the server.

In an embodiment, the current asset information includes model categories and SN numbers of every part in the server.

According to a second aspect of the present disclosure, an apparatus for authenticating a transparent supply chain based on a blockchain is provided, and the device includes:
a storage module, configured to store a transparent-supply-chain certificate and original asset information, assigned to a server at an ex-factory time of the server, in a blockchain storage system, to obtain a feature value of the blockchain, and store the feature value of the blockchain in a preset nonvolatile storage space of the server;
a reading module, configured to, in response to that the server is started, read current asset information of the server, and read the feature value of the blockchain in the preset nonvolatile storage space of the server;
a query module, configured to query in the blockchain storage system by using the feature value of the blockchain, to obtain a target transparent-supply-chain certificate and target original asset information, and compare the current asset information with the target original asset information; and
a certificate-assigning module, configured to, in response to that the current asset information is consistent with the target original asset information, assign the target transparent-supply-chain certificate to the server, to make the server obtain a work authority based on the target transparent-supply-chain certificate.

According to a third aspect of the present disclosure, a computer device is further provided, and the computer device includes:
at least one processor; and
a storage, wherein the storage stores a computer program executable in the at least one processor, and when the at least one processor executes the computer program, the at least one processor implements the aforementioned method for authenticating the transparent supply chain based on the blockchain.

According to a fourth aspect of the present disclosure, a computer-readable storage medium storing a computer program is further provided, wherein, when a processor executes the computer program, the processor implements the aforementioned method for authenticating the transparent supply chain based on the blockchain.

In addition, the present disclosure further provides the apparatus for authenticating the transparent supply chain based on the blockchain, the computer device, and the computer-readable storage medium, which may realize the above technical effects as well, and will not be repeated here.

### BRIEF DESCRIPTION OF THE DRAWINGS

In order to more clearly illustrate technical solutions of the embodiments of the disclosure and prior art, following will briefly introduce drawings needed to be used in illustrating the embodiments of the disclosure and the prior art. Apparently, the drawings in the following description are merely some embodiments of the present disclosure, and for those ordinary skilled in the field, they may further obtain other embodiments according to the provided drawings without paying creative labor.

FIG. 1 is a schematic diagram of an existing authentication method for a transparent supply chain of a server.

FIG. 2 is a schematic flowchart of a method for authenticating a transparent supply chain based on a blockchain, provided by an embodiment of the present disclosure.

FIG. 3A is a schematic diagram of interaction among a server, a control center, and a blockchain storage system provided by another embodiment of the present disclosure.

FIG. 3B is a schematic diagram of adopting the blockchain storage system in FIG. 3A to maintain an asset-information-change record.

FIG. 3C is a schematic diagram of adopting the control center in FIG. 3A to maintain an asset-information-change record.

FIG. 4 is a schematic flowchart of saving data in a blockchain storage system provided by another embodiment of the present disclosure.

FIG. 5 is a schematic flowchart of a method for authenticating a transparent supply chain based on a blockchain, provided by another embodiment of the present disclosure.

FIG. 6 is schematic diagram of an internal structure of a computer device in another embodiment of the present disclosure.

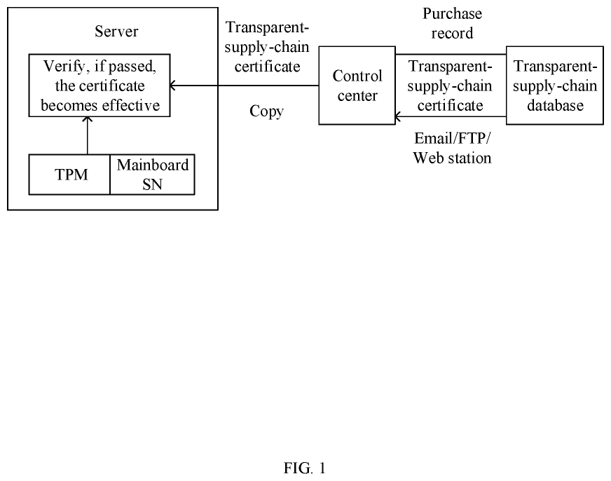

### DETAILED DESCRIPTION OF THE EMBODIMENTS

In order to make purposes, technical solutions and advantages of the present disclosure clearer, the following will further describe the embodiments of the present disclosure in detail in combination with the concrete embodiments and with reference to the accompanying drawings.

It should be noted that every expression using “first” and “second” in the embodiments of the present disclosure are for a purpose of distinguishing two different entities or parameters with the same name. It may be seen that the “first” and “second” are merely for convenience of expression and should not be construed as a limitation on the embodiments of the present disclosure, which will not illustrated one by one in the subsequent embodiments.

The existing authentication method for the transparent supply chain has following defects: first, whether original information of the transparent supply chain is stored in a central server or a local server, there is a risk of being lost or tampered with; second, except the SN of the mainboard and the TPM, there is a lack of inspection on whether assets of other parts in equipment comply with data of the supply chain; third, a transmission of the transparent-supply-chain certificate is a manual transmission, so there is a risk of error.

In view of the above, it is necessary to provide a method for authenticating a transparent supply chain based on a blockchain, and an apparatus, a device and a medium thereof, having higher security and being capable of automatic authentication, for the above technical problems.

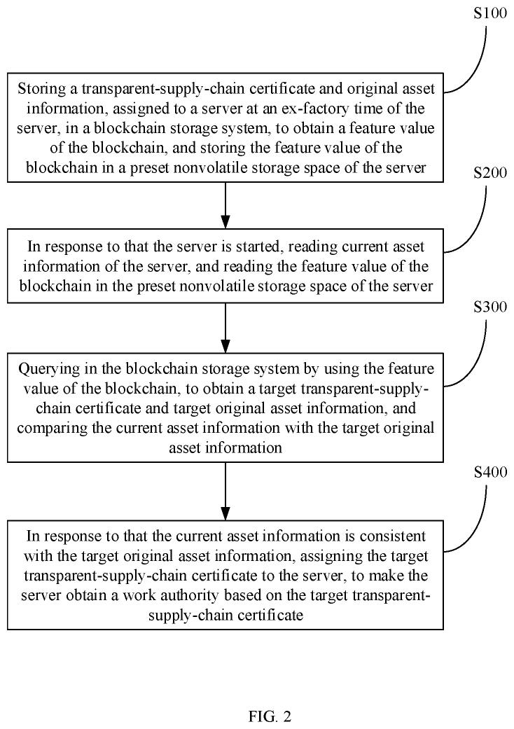

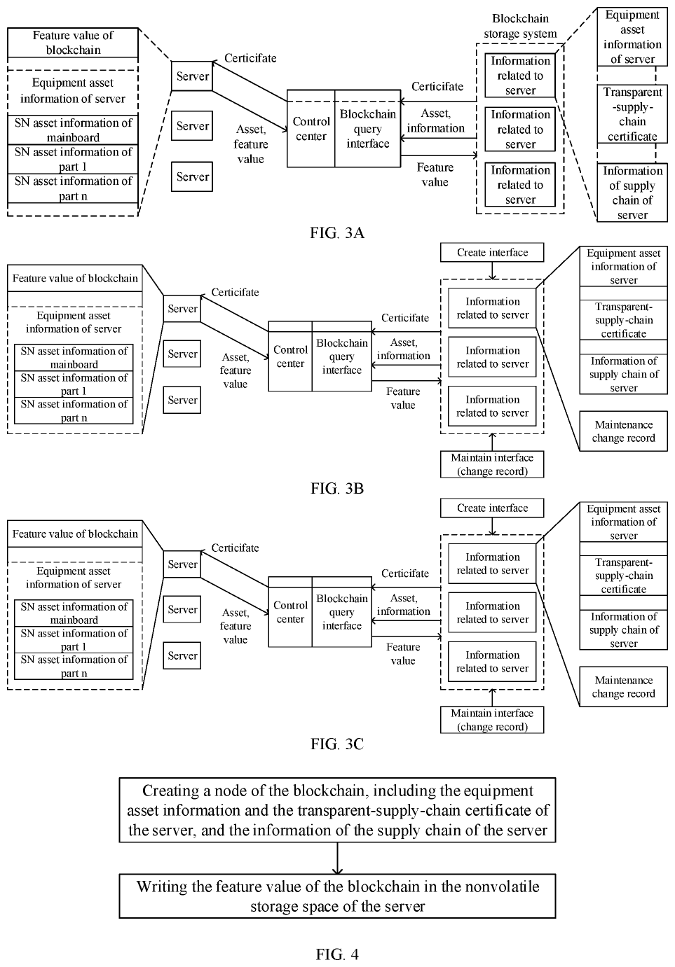

In an embodiment, referring to that shown in FIG. 2 and FIG. 3A, the present disclosure provides a method for authenticating a transparent supply chain based on a blockchain, and the method includes:

S100, storing a transparent-supply-chain certificate and original asset information, assigned to a server at an ex-factory time of the server, in a blockchain storage system, to obtain a feature value of the blockchain, and storing the feature value of the blockchain in a preset nonvolatile storage space of the server.

Among them, a manner of the blockchain storage system has characteristics of decentralization, traceability, and non-tamperability, which ensures that information of the supply chain will not be lost or tampered with. The feature value of the blockchain may be assigned to a server at an ex-factory time of the server.

S200, in response to that the server is started, reading current asset information of the server, and reading the feature value of the blockchain in the preset nonvolatile storage space of the server.

S300, querying in the blockchain storage system by using the feature value of the blockchain, to obtain a target transparent-supply-chain certificate and target original asset information, and comparing the current asset information with the target original asset information.

S400, in response to that the current asset information is consistent with the target original asset information, assigning the target transparent-supply-chain certificate to the server, to make the server obtain a work authority based on the target transparent-supply-chain certificate.

The above-mentioned method for authenticating the transparent supply chain based on the blockchain obtains the feature value of the blockchain by storing the transparent-supply-chain certificate and the original asset information, assigned to the server at an ex-factory time of the server, in the blockchain storage system, and stores the feature value of the blockchain in the preset nonvolatile storage space of the server. The method reads the current asset information and the feature value of the blockchain of the server in response to that the server is started. The method queries in the blockchain storage system by using the feature value of the blockchain to obtain the target transparent-supply-chain certificate and the target original asset information. In response to that the current asset information is consistent with the target original asset information, the method assigns the target transparent-supply-chain certificate to the server, so that the server may obtain the work authority based on the target transparent-supply-chain certificate. The information of the supply chain is saved in a manner the blockchain, to ensure that the information of the supply chain will not be lost or tampered with, which realizes automation and credibility of authentication for the transparent supply chain for the server.

In another embodiment, referring to that shown in FIG. 3B, considering that asset information of the parts of the server may change due to factors, for example, maintenance or expansion of the server during a working process of the server, it is necessary to maintain an asset-information-change record of the parts, and a historical change factor shall be considered together, in a comparison for the asset information. In response to that an authority for modifying the blockchain storage system is given to a user, the method further includes:

S510A, obtaining maintenance record data of the server, and determining the asset-information-change record according to the maintenance record data.

S520A, storing the asset-information-change record in the blockchain storage system.

In another embodiment, referring to that shown in FIG. 3C, in response to that a control center operates the above blockchain storage system, the aforementioned step S300 includes:

S310, determining a target block based on the feature value of the blockchain.

S320, in response to that no asset-information-change record is presented in the target block, using the original asset information stored in the target block as the target asset information.

S330, in response to that the asset-information-change record is presented in the target block, determining the target asset information according to the original asset information stored in the target block and the asset-information-change record.

S340, using the transparent-supply-chain certificate stored in the target block as the target transparent-supply-chain certificate.

The above-mentioned method for authenticating the transparent supply chain based on the blockchain, may use the feature value of the blockchain of the server to synchronously obtain equipment asset information, the transparent-supply-chain certificate, process information of the supply chain and the asset-information-change record, by inputting the change record into the blockchain storage system and interrelating the change record with the feature value of the blockchain of the server in response to that the asset information of the parts of the server is changed due to the maintenance or expansion of the server. The control center uses the asset information of the server to compare it with the equipment asset information in the blockchain storage system and the asset-information-change record, to realize a function for inspecting asset.

In an embodiment, the method further includes:

S510B, in response to that the current asset information is inconsistent with the target original asset information, obtaining the maintenance record data of the server, and determining the asset-information-change record according to the maintenance record data.

S520B, determining whether the current asset information inconsistent with the target original asset information is consistent with the asset-information-change record.

S530B, in response to that the current asset information inconsistent with the target original asset information is consistent with the asset-information-change record, sending the target transparent-supply-chain certificate to the server, to make the server obtain the work authority based on the target transparent-supply-chain certificate.

It should be noted that, unlike the previous embodiments, in this embodiment, in response to that the asset information of the parts of the server changes due to the maintenance or expansion of the server, the change record is input into a maintenance-change-record database. In response to that the equipment asset information in the blockchain storage system, the transparent-supply-chain certificate, and the process information of the supply chain are obtained, the asset-information-change record is obtained from maintenance-change-record database as well. The method may use the control center to use the asset information of the server to compare it with the equipment asset information in the blockchain storage system, and the asset-information-change record in the maintenance-change-record database, to realize the function for inspecting the asset.

In another embodiment, the method further includes:

S610, storing a local certificate in a trusted platform module (TPM) of the server in advance, and comparing the target transparent-supply-chain certificate with the local certificate stored in the trusted platform module of the server.

S620, in response to that the target transparent-supply-chain certificate is the same as the local certificate, allowing the server to use the target transparent-supply-chain certificate to obtain the work authority.

S630, in response to that the target transparent-supply-chain certificate is not the same as the local certificate, preventing the server from using the target transparent-supply-chain certificate to obtain the work authority.

In an embodiment, the preset nonvolatile storage space is an EEPROM (Electrically Erasable Programmable Read-Only Memory) electronic tag in a field replaceable unit (FRU) provided in the server.

In an embodiment, the current asset information includes model categories and SN numbers of every part in the server.

For example, the server has a nonvolatile storage space for storing the feature value of the blockchain of the server, the model category and an SN asset number, of a mainboard, and the model categories and SN asset numbers, of respective sub-parts. The nonvolatile storage space may be implemented by the EEPROM electronic tag in the field replaceable unit (FRU), or by other means, which supports being accessed and read through an I2C (Inter-Integrated Circuit) channel of a BMC (Baseboard Management Controller) of the server, or through other means.

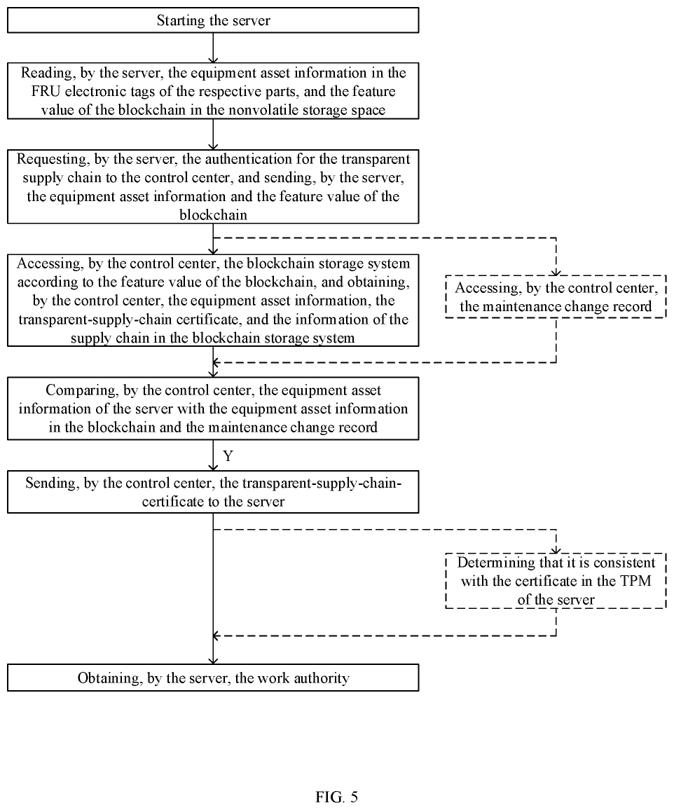

In another embodiment, in order to facilitate understanding of the technical solutions of the present disclosure, the following will be described by taking the control center as a main body of execution. For details, referring to that shown in FIG. 4 and FIG. 5, the method of the present disclosure may be implemented by following steps:

Step 1: in response to that the server is produced, entering the information of the supply chain, the equipment asset information of the respective parts, and the transparent-supply-chain certificate, of the server, into a system; and uploading the information of the supply chain, the equipment asset information of the respective parts, and the transparent-supply-chain certificate, of the server, to the blockchain storage system, to obtain a unique feature value of the blockchain corresponding to the server, wherein information related to the server may be retrieved in the blockchain storage system according to the feature value.

Step 2, in response to that the server is produced, assigning the feature value of the blockchain together with the server, and storing the feature value of the blockchain in the nonvolatile storage space of the server.

Step 3: in response to that the server is started, automatically reading, by the server, the feature value of the blockchain and the SN asset information (including the category and number) of the mainboard in the nonvolatile storage space of the mainboard of the equipment (the server), and reading, by the server, the SN asset information (including the categories and numbers) of the respective sub-parts in the nonvolatile storage spaces of the respective sub-parts.

Step 4, automatically initiating, by the server, an authentication application for the transparent supply chain to the control center, and sending, by the server, the feature value of the blockchain of the transparent supply chain, and the SN asset information of the mainboard and the respective parts of the server.

Step 5, accessing, by the control center, the blockchain storage system through the feature value of the blockchain, and automatically obtaining, by the control center, the equipment asset information, the transparent-supply-chain certificate, and the process information of the supply chain in the blockchain storage system.

Step 6: in response to that the control center automatically compares the equipment asset information in the blockchain storage system with the equipment asset information uploaded by the server, and determines that the equipment asset information in the blockchain is consistent with the equipment asset information uploaded by the serve, sending, by the control center, the transparent-supply-chain certificate to the server.

Step 7, obtaining, by the server, the transparent-supply-chain certificate, to have the corresponding work authority.

Step 8: maintaining, by the control center, a maintenance-record-change table, to record changes of the asset information of the sub-parts of the server due to the maintenance or expansion of the server, wherein, in response to that the control center compares consistency of the asset information, a change process of the asset information of the parts in the maintenance-record-change table needs to be considered.

Step 9: in a condition that a local certificate corresponding to the transparent-supply-chain certificate is saved in a TPM module of the server, in response to that the local certificate of the server is verified to be matched with the transparent-supply-chain certificate, making the server to have the corresponding work authority.

In the above-mentioned method for authenticating the transparent supply chain based on the blockchain, information of the transparent supply chain is saved in a form of the blockchain, and the feature value of the blockchain is assigned together with the server, which ensures that the information of the supply chain will not be lost or tampered with. Every asset is verified to realize that there is no omission of supply information of the server. After the server is powered on, the feature value of the blockchain and key asset information are automatically uploaded, and the control center automatically obtains information of the blockchain, checks compliance of the asset, and assigns a certificate to the server, to realize automation and credibility of authentication of the transparent supply chain of the server.

In another embodiment, the present disclosure further provides an apparatus for authenticating a transparent supply chain based on a blockchain, and the apparatus includes:

A storage module, configured to store a transparent-supply-chain certificate and original asset information, assigned to a server at an ex-factory time of the server, in a blockchain storage system, to obtain a feature value of the blockchain, and store the feature value of the blockchain in a preset nonvolatile storage space of the server.

A reading module, configured to, in response to that the server is started, read current asset information of the server, and read the feature value of the blockchain in the preset nonvolatile storage space of the server.

A query module, configured to query in the blockchain storage system by using the feature value of the blockchain, to obtain a target transparent-supply-chain certificate and target original asset information, and compare the current asset information with the target original asset information.

A certificate-assigning module, configured to, in response to that the current asset information is consistent with the target original asset information, assign the target transparent-supply-chain certificate to the server, to make the server obtain a work authority based on the target transparent-supply-chain certificate.

It should be noted that, for concrete definitions of the apparatus for authenticating the transparent supply chain based on the blockchain, please refer to the above definitions of the method for authenticating the transparent supply chain based on the blockchain, which will not be repeated here. The respective modules in the above-mentioned apparatus for authenticating the transparent supply chain based on the blockchain may be implemented in whole or in part by software, hardware and combinations thereof. The above respective modules may be embedded in or separate of a processor in a computer device in a form of hardware, or stored in a storage in the computer device in a form of software, such that the processor may invoke them and execute operations corresponding to the above modules.

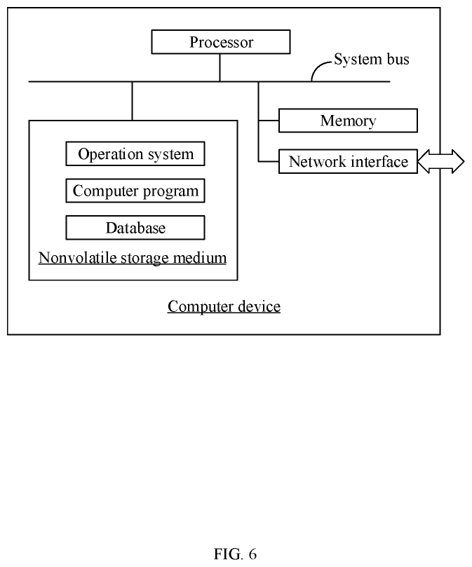

According to another aspect of the present disclosure, a computer device is provided, and the computer device may be a server. A schematic diagram of an internal structure of the computer device may be referred to FIG. 6. The computer device includes at least one processor, a storage, a network interface and a database, connected by a system bus. Among them, the processor of the computer device is configured to provide computing and control capabilities. The storage of the computer device includes a nonvolatile storage medium and a memory. The nonvolatile storage medium stores an operating system, a computer program and a database. The memory provides an environment for execution of the operating system and computer programs in the nonvolatile storage medium. The database of the computer device is configured to store data. The network interface of the computer device is configured to communicate with an external terminal through a network connection. In response to that the computer program is executed by the processor, the processor implements the method for authenticating the transparent supply chain based on the blockchain described above.

Those of ordinary skill in the art may understand that a whole or a part of processes in the methods of the above embodiments may be implemented by instructing relevant hardware through the computer program. The computer program may be stored in a nonvolatile computer-readable storage medium, and in response to the computer program is executed by a processer, the processor implements the processes of the respective embodiments of the above-mentioned method. Among them, any reference to the memory, the storage, the database or other medium used in the respective embodiments provided in the disclosure may include a nonvolatile and/or volatile storage. The nonvolatile storage may include read-only memory (ROM), programmable ROM (PROM), electrically programmable ROM (EPROM), electrically erasable programmable ROM (EEPROM), or flash memory. The volatile memory may include random access memory (RAM) or external cache memory. By way of illustration and not limitation, the RAM is available in various forms, for example, static RAM (SRAM), dynamic RAM (DRAM), synchronous DRAM (SDRAM), double data rate SDRAM (DDRSDRAM), enhanced SDRAM (ESDRAM), synchronous chain Road (Synchlink) DRAM (SLDRAM), memory bus (Rambus) direct RAM (RDRAM), direct memory bus dynamic RAM (DRDRAM), memory bus dynamic RAM (RDRAM), and so on.

Respective technical features of the above embodiments may be combined arbitrarily. For sake of brevity, the above embodiments do not describe every possible combination of the respective technical features. However, as long as there is no contradiction in the combination of these technical features, the combination shall be considered to be a range described in the specification.

The above-mentioned embodiments merely represent several embodiments of the present disclosure, and descriptions thereof are relatively concrete and detailed, but should not be construed as a limitation on the scope of the patent application. It should be noted that, for those skilled in the art, without departing from concept of the present disclosure, several modifications and improvements may be made, every one of which belong to a protection scope of the present disclosure. Therefore, the protection scope of the patent of the present disclosure shall be subject to the appended claims.

1. A method for authenticating a transparent supply chain based on a blockchain, comprising:
storing a transparent-supply-chain certificate and original asset information, assigned to a server at an ex-factory time of the server, in a blockchain storage system, to obtain a feature value of the blockchain, and storing the feature value of the blockchain in a preset nonvolatile storage space of the server;
in response to that the server is started, reading current asset information of the server, and reading the feature value of the blockchain in the preset nonvolatile storage space of the server;
querying in the blockchain storage system by using the feature value of the blockchain, to obtain a target transparent-supply-chain certificate and target original asset information, and comparing the current asset information with the target original asset information; and
in response to that the current asset information is consistent with the target original asset information, assigning the target transparent-supply-chain certificate to the server, to make the server obtain a work authority based on the target transparent-supply-chain certificate.

2. The method according to claim 1, further comprising:
obtaining maintenance record data of the server, and determining an asset-information-change record according to the maintenance record data; and
storing the asset-information-change record in the blockchain storage system.

3. The method according to claim 2, wherein the querying in the blockchain storage system by using the feature value of the blockchain to obtain the target transparent-supply-chain certificate and the target original asset information and comparing the current asset information with the target original asset information, comprises:
determining a target block based on the feature value of the blockchain;
in response to that no asset-information-change record is presented in the target block, using the original asset information stored in the target block as target asset information;
in response to that the asset-information-change record is presented in the target block, determining the target asset information according to the original asset information stored in the target block and the asset-information-change record; and
using the transparent-supply-chain certificate stored in the target block as the target transparent-supply-chain certificate.

4. The method according to claim 1, further comprising:
in response to that the current asset information is inconsistent with the target original asset information, obtaining maintenance record data of the server, and determining an asset-information-change record according to the maintenance record data;
determining whether the current asset information inconsistent with the target original asset information is consistent with the asset-information-change record; and
in response to that the current asset information inconsistent with the target original asset information is consistent with the asset-information-change record, sending the target transparent-supply-chain certificate to the server, to make the server obtain the work authority based on the target transparent-supply-chain certificate.

5. The method according to claim 1, further comprising:
storing a local certificate in a trusted platform module of the server in advance, and comparing the target transparent-supply-chain certificate with the local certificate stored in the trusted platform module of the server;
in response to that the target transparent-supply-chain certificate is the same as the local certificate, allowing the server to use the target transparent-supply-chain certificate to obtain the work authority; and
in response to that the target transparent-supply-chain certificate is not the same as the local certificate, preventing the server from using the target transparent-supply-chain certificate to obtain the work authority.

6. The method according to claim 1, wherein the preset nonvolatile storage space is an EEPROM electronic tag in a field replaceable unit provided in the server.

7. The method according to claim 1, wherein the current asset information comprises model categories and SN numbers of every part in the server.

8. (canceled)

9. A computer device, comprising:
at least one processor; and
a storage, wherein the storage stores a computer program executable in the at least one processor, and when the at least one processor executes the computer program, the at least one processor implements the method according to claim 1.

10. A computer-readable storage medium, storing a computer program, wherein, when a processor executes the computer program, the processor implements the method according to claim 1.

11. The method according to claim 1, wherein the feature value of the blockchain is assigned to the server at the ex-factory time of the server.

12. The method according to claim 2, wherein the comparing the current asset information with the target original asset information is conducted together with the asset-information-change record of every part of the server.

13. The method according to claim 2, wherein the asset-information-change record is interrelated with the feature value of the blockchain of the server.

14. The method according to claim 13, wherein the feature value of the blockchain of the server is used to synchronously obtain equipment asset information, the transparent-supply-chain certificate, process information of the supply chain and the asset-information-change record.

15. The method according to claim 2, wherein the asset-information-change record is saved in a maintenance-change-record database.

16. The method according to claim 15, wherein the comparing the current asset information with the target original asset information comprises:
comparing the current asset information with equipment asset information in the blockchain storage system, and the asset-information-change record in the maintenance-change-record database.

17. The method according to claim 7, wherein the model category and SN number comprise a model category and a SN number of a mainboard of the server.

18. The method according to claim 1, wherein the preset nonvolatile storage space supports being accessed and read through an inter-integrated circuit channel of a baseboard management controller of the server.

19. The method according to claim 2, wherein a control center maintains a maintenance-record-change table, to record the asset-information-change record.

20. The method according to claim 1, wherein a local certificate corresponding to the transparent-supply-chain certificate is saved in a trusted platform module of the server, and in response to that the local certificate is verified to be matched with the transparent-supply-chain certificate, the server has the work authority.

21. The method according to claim 1, wherein, after the server reads the current asset information of the server and the feature value of the blockchain in the preset nonvolatile storage space of the server, the server automatically sends the current asset information and the feature value of the blockchain to a control center.
